(19) United States
(12) Patent Application Publication
(10) Pub. No.: US 2018/0287979 A1
(43) Pub. Date: Oct. 4, 2018

(54) SYSTEMS AND METHODS FOR GENERATING CONTENT

(71) Applicant: Facebook, Inc., Menlo Park, CA (US)

(72) Inventors: Thomas Frederick Dimson, Stanford, CA (US); Richard George Arnold, Hoboken, NJ (US); Ian McIntyre Silber, San Jose, CA (US); Ryan Michael O'Rourke, San Francisco, CA (US)

(21) Appl. No.: 15/717,888

(22) Filed: Sep. 27, 2017

Related U.S. Application Data
(60) Provisional application No. 62/478,559, filed on Mar. 29, 2017.

(51) Int. Cl. H04L 12/58; G06F 17/30

(52) U.S. Cl. CPC H04L 51/12; G06F 17/30026; H04L 67/18; H04L 51/32; G06F 17/30864

(57) ABSTRACT

Systems, methods, and non-transitory computer-readable media can generate at least one multi-author story using content items that satisfy one or more grouping criteria associated with the multi-author story, wherein the content items were previously published by users of a social networking system and provide access to the multi-author story to one or more users of the social networking system that satisfy one or more access restrictions associated with the multi-author story.

### CROSS-REFERENCE TO RELATED APPLICATIONS

This application claims priority to U.S. Provisional Patent Application No. 62/478,559, filed on Mar. 29, 2017 and entitled “SYSTEMS AND METHODS FOR GENERATING CONTENT”, which is incorporated in its entirety herein by reference.

### FIELD OF THE INVENTION

The present technology relates to the field of content generation. More particularly, the present technology relates to techniques for generating content-based stories.

### BACKGROUND

Users often utilize computing devices for a wide variety of purposes. Users can use their computing devices to, for example, interact with one another, access media content, share media content, and create media content. In some cases, media content can be provided by members of a social network. The media content can include one or a combination of text, images, videos, and audio. The media content may be published to the social network for consumption by others.

Under conventional approaches, users may post various content items to a social networking system. In general, content items posted by a first user can be included in the respective content feeds of other users of the social networking system, for example, that have “followed” the first user. By following (or subscribing to) the first user, some or all content that is produced, or posted, by the first user may be included in the respective content feeds of the following users. A user following the first user can simply unfollow the first user to prevent new content that is produced by the first user from being included in the following user's content feed.

### SUMMARY

Various embodiments of the present disclosure can include systems, methods, and non-transitory computer readable media configured to generating at least one multi-author story using content items that satisfy one or more grouping criteria associated with the multi-author story, wherein the content items were previously published by users of a social networking system and providing access to the multi-author story to one or more users of the social networking system that satisfy one or more access restrictions associated with the multi-author story.

In some embodiments, the multi-author story corresponds to a given geographic location, and wherein the multi-author story is generated by grouping content items that correspond to the geographic location.

In some embodiments, a content item corresponding to the geographic location is identified based at least in part on text associated with the content item, geolocation information associated with the content item, subject matter captured in the content item, or content overlays inserted in the content item that reference the geographic location.

In some embodiments, the multi-author story corresponds to a given event, and wherein the multi-author story is generated by grouping content items that correspond to the event.

In some embodiments, the multi-author story corresponds to live broadcasts, and wherein the multi-author story is generated by grouping live broadcasts being streamed through the social networking system.

In some embodiments, the multi-author story corresponds to a given song, and wherein the multi-author story is generated by grouping content items in which at least a portion of the given song is audible.

In some embodiments, the multi-author story corresponds to trending subject matter, and wherein the multi-author story is generated by grouping content items that include the trending subject matter.

In some embodiments, access to the multi-author story is restricted to users that are located in one or more pre-defined geographic locations.

In some embodiments, access to the multi-author story is restricted to users that have demonstrated one or more pre-defined interests.

In some embodiments, access to the multi-author story is restricted to users that are following one or more pre-defined user accounts in the social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content provider module, according to an embodiment of the present disclosure.

FIG. 2 illustrates an example multi-author story module, according to an embodiment of the present disclosure.

FIG. 3A illustrates an example content grouping module, according to an embodiment of the present disclosure.

FIG. 3B illustrates an example content distribution module, according to an embodiment of the present disclosure.

FIGS. 4A-B illustrate example interfaces, according to an embodiment of the present disclosure.

FIG. 5 illustrates an example method, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Generating Content

As mentioned, users often utilize computing devices for a wide variety of purposes. Users can use their computing devices to, for example, interact with one another, access media content, share media content, and create media content. In some cases, media content items can include postings from members of an online community or platform, such as a social network. The postings may include one or a combination of text, images, videos, and audio. The postings may be published to the social network for consumption by others. Under conventional approaches, media content items posted by a member can be included in a profile of the member on the social network. In other instances, media content items posted by the member can appear in respective media content feeds of other users who are members of the social network. The other users can be connections of the member who posted the media content items.

As mentioned, under conventional approaches, users can post content for publication through a social networking system. Such posted content can include text, media (e.g., images, videos, audio), or a combination thereof. In general, content posted publicly can be accessed by any user of the social networking system. However, there may be instances in which such widespread dissemination of content is not appropriate or desirable. Further, given the vast amount of content that can be published through the social networking system, providing users with access to all published content can be overwhelming and may degrade the overall user experience.

An improved approach rooted in computer technology overcomes the foregoing and other disadvantages associated with conventional approaches specifically arising in the realm of computer technology. For example, a multi-author story can be generated using content items that satisfy one or more grouping criteria associated with the multi-author story. These content items may have been previously published by users of a social networking system. Further, access to the multi-author story can be provided to one or more users of the social networking system that satisfy one or more access restrictions associated with the multi-author story. More details relating to the disclosed technology are provided below.

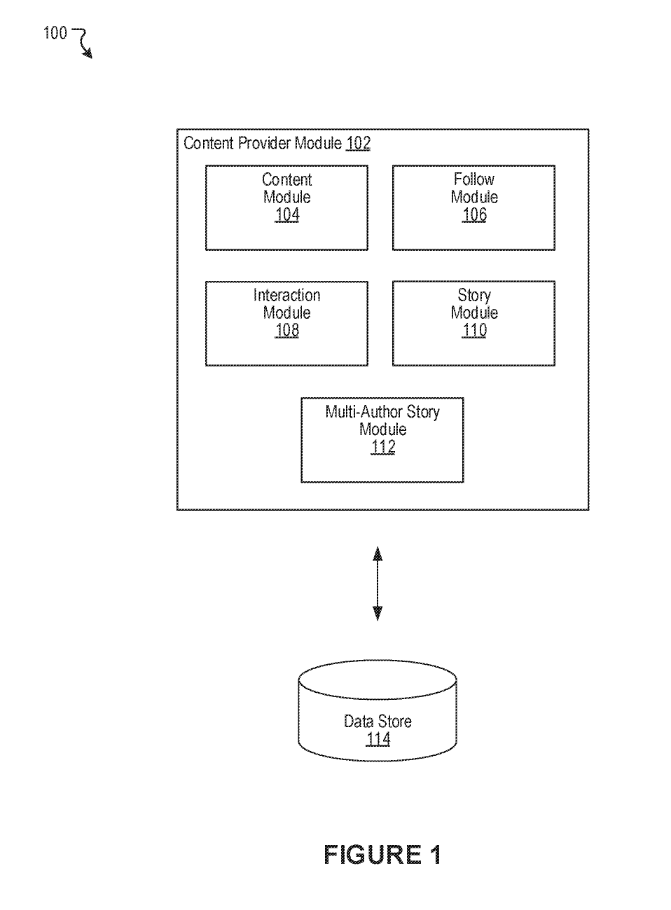

FIG. 1 illustrates an example system 100 including an example content provider module 102, according to an embodiment of the present disclosure. As shown in the example of FIG. 1, the content provider module 102 can include a content module 104, a follow module 106, an interaction module 108, a story module 110, and a multi-author story module 112. In some instances, the example system 100 can include at least one data store 114. The components (e.g., modules, elements, etc.) shown in this figure and all figures herein are exemplary only, and other implementations may include additional, fewer, integrated, or different components. Some components may not be shown so as not to obscure relevant details.

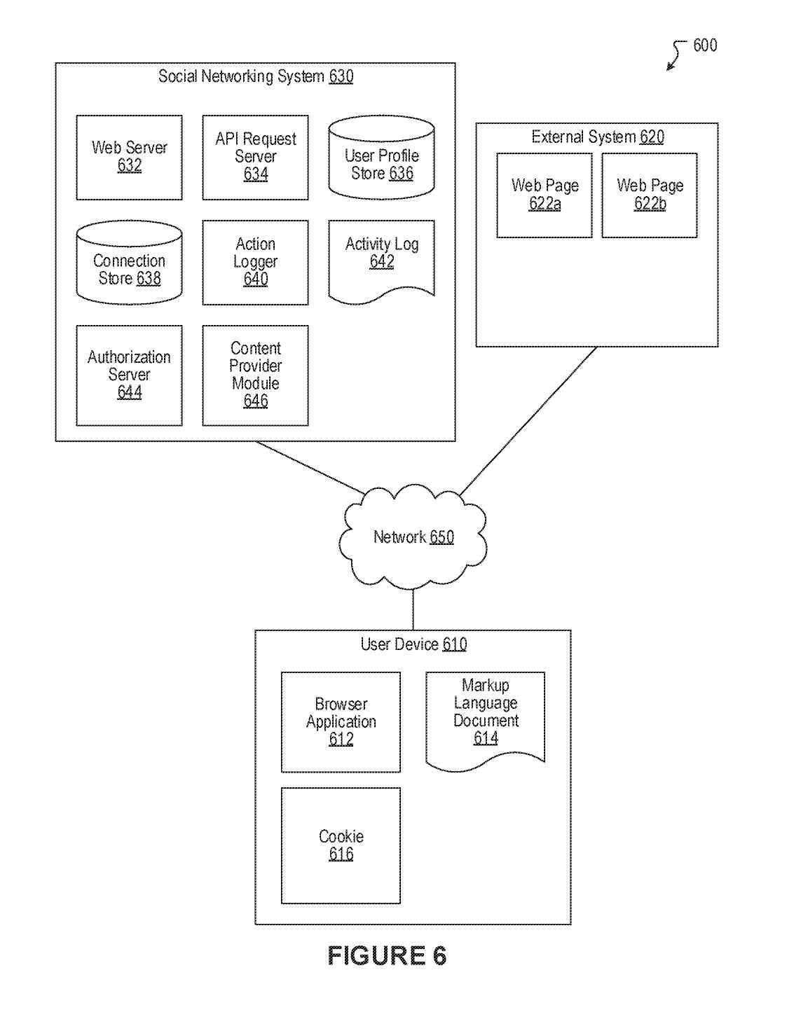

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be implemented, in part or in whole, as software running on one or more computing devices or systems, such as on a user or client computing device. In one example, the content provider module 102 or at least a portion thereof can be implemented as or within an application (e.g., app), a program, or an applet, etc., running on a user computing device or a client computing system, such as the user device 610 of FIG. 6. In another example, the content provider module 102 or at least a portion thereof can be implemented using one or more computing devices or systems that include one or more servers, such as network servers or cloud servers. In some instances, the content provider module 102 can, in part or in whole, be implemented within or configured to operate in conjunction with a social networking system (or service), such as the social networking system 630 of FIG. 6.

The content provider module 102 can be configured to communicate and/or operate with the at least one data store 114, as shown in the example system 100. The at least one data store 114 can be configured to store and maintain various types of data. For example, the data store 114 can store information describing various content that has been posted by users of a social networking system. In some implementations, the at least one data store 114 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 114 can store information associated with users, such as user identifiers, user information, profile information, user specified settings, content produced or posted by users, and various other types of user data.

The content module 104 can be configured to provide users with access to content (e.g., media content items) that is available through a social networking system. In some instances, this content can include content items that are posted in content feeds accessible through the social networking system. For example, the content module 104 can provide a first user with access to media content items through an interface that is provided by a software application (e.g., a social networking application) running on a computing device of the first user. The first user can also interact with the interface to post content items to the social networking system. Such content items may include text, images, audio, and videos, for example. For example, the first user can submit a post to be published through the social networking system. In some embodiments, the post can include, or reference, one or more content items.

In various embodiments, other users of the social networking system can access content items posted by the first user. In one example, the other users can access the content items by searching for the first user, for example, by user name through an interface provided by a software application (e.g., a social networking application, browser, etc.) running on their respective computing devices. In some instances, some users may want to see content items posted by the first user in their respective content feed. To cause content items posted by the first user to be included in their respective content feed, a user can select an option through the interface to subscribe to, or “follow”, the first user. The follow module 106 can process the user's request by identifying the user as a follower of (or “friend” of) the first user in the social networking system. As a result, some or all content items that are posted by the first user can automatically be included in the respective content feed of the user. If the user decides that they no longer want to see content from the first user in their respective content feed, the user can select an option through the interface to “unfollow” the first user. As a result, the follow module 106 can remove the association between the user and the first user so that content items posted by the first user are no longer included in the content feed of the user.

In some instances, users may want to interact with posted content items. For example, a user may want to endorse, or “like”, a content item. In this example, the user can select an option provided in the interface to like the desired content item. The interaction module 108 can determine when a user likes a given content item and can store information describing this relationship. The interaction module 108 can also determine when other forms of user interaction are performed and can store information describing the interaction (e.g., information describing the type of interaction, the identity of the user, the identity of the user that posted the content item, and the content item, to name some examples). For example, the user may want to post a comment in response to a content item. In this example, the user can select an option provided in the interface to enter and post the comment for the desired content item. The interaction module 108 can determine when a user posts a comment in response to a given content item and can store information describing this relationship. Other forms of user interaction can include reacting to a content item (e.g., selecting an option that corresponds to a particular reaction, e.g., happy, sad, angry, etc.) and sharing a content item, to name some examples.

In some embodiments, the story module 110 can provide an option that allows users to post their content as stories. In such embodiments, each user has a corresponding story in which the user can post content. When a user's story is accessed by another user, the story module 110 can provide content posted in the story to the other user for viewing. In general, content posted in a user's story may be accessible by any user of the social networking system. In some embodiments, content posted in a user's story may only be accessible to followers of the user. In some embodiments, user stories expire after a pre-defined time interval (e.g., every 24 hours). In such embodiments, content posted in stories is treated as ephemeral content that is made inaccessible once the pre-defined time interval has elapsed. In contrast, content posted in a user's content feed can be treated as non-ephemeral content that remains accessible for an indefinite period of time.

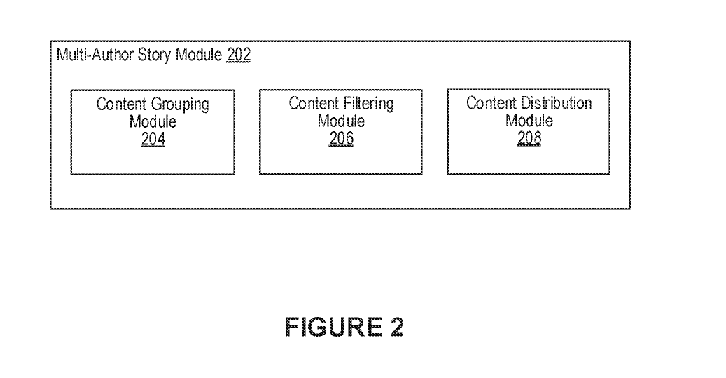

In various embodiments, the multi-author story module 112 is configured to generate and distribute stories through the social networking system. More details regarding the multi-author story module 112 will be provided below with reference to FIG. 2.

FIG. 2 illustrates a multi-author story module 202, according to an embodiment of the present disclosure. In some embodiments, the multi-author story module 112 of FIG. 1 can be implemented with the multi-author story module 202. As shown in the example of FIG. 2, the multi-author story module 202 can include a content grouping module 204, content filtering module 206, and a content distribution module 208.

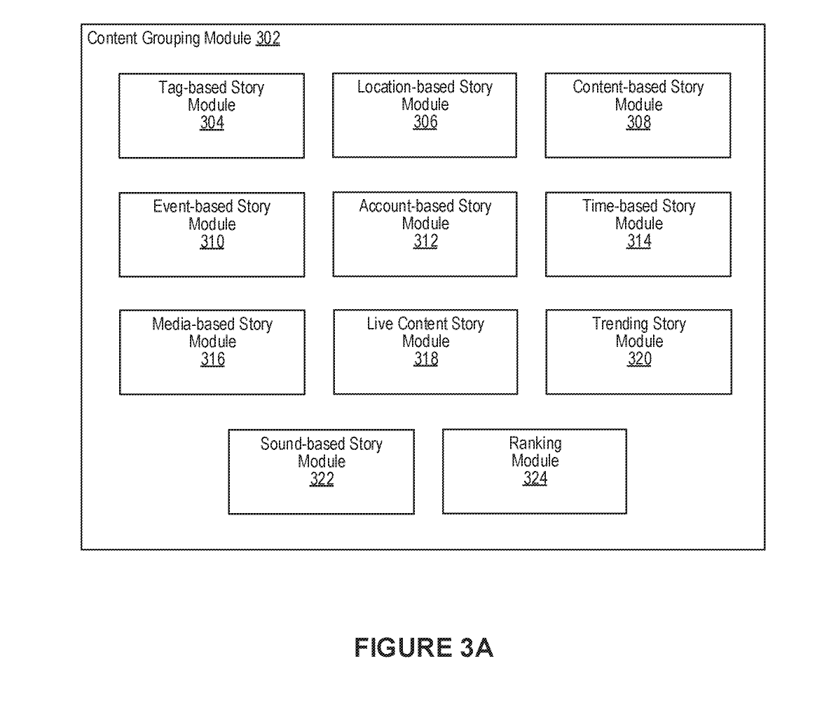

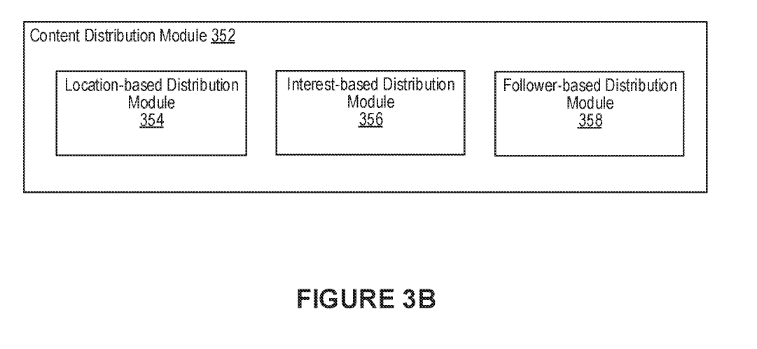

In various embodiments, the content grouping module 204 can be configured to generate multi-author stories by grouping content posted through the social networking system. In some embodiments, the content being grouped may be selected from content that was posted by users in their respective stories (e.g., ephemeral content), content that was posted by users in their respective content feeds (e.g., non-ephemeral content), or a combination thereof. When generating a multi-author story, the content grouping module 204 can group content based on various criteria associated with the multi-author story being generated. For example, when generating a multi-author story that corresponds to a particular geographic region (e.g., New York, N.Y.), the content grouping module 204 can group content items that relate to the city of New York. More details regarding the content grouping module 204 will be provided below with reference to FIG. 3A.

The content filtering module 206 can be configured to filter content that was grouped by the content grouping module 204. This filtering can be performed prior to generating a multi-author story from the grouped content. In some embodiments, the content filtering module 206 filters the grouped content to remove content items that fail to satisfy one or more threshold measures of quality. For example, the content filtering module 206 can remove content items that include objectionable, or inappropriate, content. In another example, the content filtering module 206 can remove content items that do not satisfy one or more threshold media quality metrics (e.g., image quality, video quality, or audio quality). In yet another example, the content filtering module 206 can remove content items that were posted by certain users. In some embodiments, the content filtering module 206 can remove content items that do not satisfy a threshold amount of user engagement (e.g., threshold number of views, likes, comments, re-shares, etc.).

In various embodiments, the content distribution module 208 can be configured to provide users with access to multi-author stories. In some embodiments, each multi-author story is associated with certain criteria that must be satisfied before a user is able to access the multi-author story. For example, access to the multi-author story corresponding to New York, N.Y. may be restricted to users that are geographically located in the city of New York. In this example, the content distribution module 208 can determine whether a given user satisfies this geography-based requirement before providing the user with access to the multi-author story. More details regarding the content distribution module 208 will be provided below with reference to FIG. 3B.

FIG. 3A illustrates an example content grouping module 302, according to an embodiment of the present disclosure. In some embodiments, the content grouping module 204 of FIG. 2 can be implemented with the content grouping module 302. As shown in the example of FIG. 3A, the content grouping module 302 can include a tag-based story module 304, a location-based story module 306, a content-based story module 308, an event-based story module 310, an account-based story module 312, a time-based story module 314, a media-based story 316, a live content story module 318, a trending story module 320, a sound-based story module 322, and a ranking module 324.

As mentioned, the content grouping module 302 can be configured to generate multi-author stories for various entities and topics by grouping content posted through the social networking system. In various embodiments, content can be grouped based on various criteria associated with the multi-author story being generated. In general, multi-author stories can be generated using any of the approaches described with respect to the tag-based story module 304, the location-based story module 306, the content-based story module 308, the event-based story module 310, the account-based story module 312, the time-based story module 314, the media-based story 316, the live content story module 318, the trending story module 320, and the sound-based story module 322 either alone or in combination. For example, a multi-author story can be generated using content items that both relate to a given geographic location and that include pre-defined subject matter.

In some embodiments, a multi-author story may be generated using content items that share one or more pre-defined tags. For example, users often post content items with tags (e.g., hash tags). These tags may provide context about the subject matter that is captured in content items (e.g., “#NYCsummer2017”). In such embodiments, the tag-based story module 304 can generate the multi-author story by grouping content items that share one or more of the tags associated with the multi-author story. In some instances, users may provide descriptive text with their posts (e.g., “Indie Music Festival 2017”). In such instances, the tag-based story module 304 can evaluate text included with content items to identify pre-defined text that relates to the multi-author story (e.g., “Indie Music Festival”). Content items associated with such pre-defined text can be included in the group of content items being used to generate the multi-author story.

In some embodiments, a multi-author story may be generated using content items that relate to a given geographic location (e.g., point of interest, city, state, country, etc.). In such embodiments, the location-based story module 306 can generate the multi-author story by grouping content items that relate to the geographic location. The content items to be grouped may be identified in a number of ways. In some embodiments, the location-based story module 306 may identify content items that correspond to the geographic location based on geolocation information provided by user devices from which the content items were posted. In some instances, this geolocation information may be included as metadata associated with posted content items. In some embodiments, the location-based story module 306 may identify content items that correspond to the geographic location based on text associated with the content items. For example, content items that include tags referencing the geographic location (e.g., “#bigapple”) can be grouped with content items from which the multi-author story for the geographic location will be generated. In some embodiments, the location-based story module 306 may identify content items that correspond to the geographic location based on the subject matter reflected in the content items. For example, the location-based story module 306 may employ generally known object detection techniques to identify content items that include objects corresponding to the geographic location. These objects may correspond to pre-defined subject matter that has been associated with the geographic location. Some examples of such objects can include points of interest (e.g., landmarks), street signs, and logos. In some embodiments, the location-based story module 306 may apply generally known text recognition techniques (e.g., optical character recognition) to identify content items that include text corresponding to the geographic location. For example, when evaluating an image of a New York City cab, the location-based story module 306 may recognize the text “NYC TAXI”. In this example, the location-based story module 306 can group the image with content items from which the multi-author story for the geographic location will be generated. In some embodiments, users may have the option to insert content overlays (e.g., stickers) that are associated with a given geographic location (e.g., point of interest stickers, city stickers, etc.). In such embodiments, content items that include content overlays referencing the given geographic location can be grouped with content items from which the multi-author story for the geographic location will be generated.

In some embodiments, a multi-author story may be generated using content items that capture certain types of subject matter. In such embodiments, the content-based story module 308 can generate the multi-author story by grouping content items that include pre-defined subject matter. The content items to be grouped may be identified in a number of ways. In some embodiments, the content-based story module 308 may apply generally known object detection techniques to identify content items that include one or more pre-defined objects. These objects can include logos, points of interest, or other distinctive objects (e.g., red telephone booths), to name some examples. In such embodiments, content items in which pre-defined object(s) appear can be used to generate a multi-author story relating to the pre-defined object(s).

In some embodiments, the content-based story module 308 can apply generally known text recognition techniques to identify content items that include pre-defined text. This text may be provided with the content items as descriptive text or may appear in the content items. For example, the content-based story module 308 can group all content items in which the text “spring break” appears to generate a multi-author story corresponding to spring break.

In some embodiments, the content-based story module 308 can apply generally known scene detection techniques to identify content items that capture certain types of scenes (e.g., outdoor scene, sunset scene, etc.). These content items can be used to generate a multi-author story corresponding to a type of scene.

In some embodiments, the content-based story module 308 can apply generally known sentiment analysis techniques to identify content items that reflect a certain sentiment (e.g., content items that capture a happy sentiment). These content items can be used to generate a multi-author story corresponding to the sentiment.

In some embodiments, the content-based story module 308 can identify content items in which one or more pre-defined content overlays were inserted. As mentioned, users may have the option to insert content overlays into their content items. These content overlays may include stickers (e.g., stickers referencing a city, holiday, cause, etc.). In such embodiments, content items that include pre-defined content overlays can be used to generate a multi-author story corresponding to the pre-defined content overlays. For example, content items in which users have inserted Halloween stickers can be used to generate a Halloween-themed multi-author story. In some instances, content overlays may provide semantic meaning. For example, users may have the option to insert stickers that describe their local weather (e.g., temperature sticker or weather sticker). In this example, a multi-author story may be generated using content items that include stickers corresponding to a certain weather pattern. In one example, a multi-author story may be composed of content items in which a “snow day” sticker was inserted. In another example, a multi-author story may be composed of content items that include temperature stickers corresponding to some pre-defined temperature (or temperature range). In some embodiments, users have the option to insert stickers that reference times (e.g., clock stickers) at which their respective content items were captured. These content items can be used to generate a multi-author story corresponding to a moment in time (or time period). In some embodiments, users have the option to insert stickers that reference a respective speed at which the user's device was traveling when capturing content items. In such embodiments, content items can be grouped based on their respective speeds. For example, content items captured while traveling at a threshold high speed can be used to generate a speed themed multi-author story. In some embodiments, users have the option to insert stickers that reference a respective altitude of the user's device when capturing content items. In such embodiments, these content items can be used to generate an altitude themed multi-author story. In general, information describing the respective speed and/or altitude associated with a given content item may be provided by sensors (e.g., accelerometers, gyroscopes, etc.) in a user device from which the content item was captured. Other types of content overlays may be used to identify and group content items depending on the multi-author story being generated. For example, a multi-author story may be generated from content items in which certain types of masks (e.g., character-based masks) were inserted. In another example, a multi-author story may be generated from content items in which certain types of visual filters (e.g., color filter, theme filter, etc.) were applied.

In some embodiments, a multi-author story may be generated using content items that relate to a given event (e.g., county fair, concert, conference, etc.). In such embodiments, the event-based story module 310 can generate the multi-author story by grouping content items that relate to the event. The content items to be grouped may be identified in a number of ways. In some embodiments, the event-based story module 310 may identify content items that correspond to the event based on geolocation information provided by user devices from which the content items were posted. As mentioned, this geolocation information may be included as metadata associated with posted content items. In some embodiments, the event-based story module 310 may identify content items that correspond to the event based on their geolocation information and timestamps. For example, content items that were posted from a geographic location and at a time corresponding to the event can be used to generate a multi-author story corresponding to the event. In some embodiments, the event-based story module 310 may identify content items that correspond to the event based on text associated with the content items (e.g., tags or descriptive text referencing the event). In some embodiments, the event-based story module 310 may identify content items that correspond to the event based on the subject matter reflected in the content items. For example, the event-based story module 310 may employ generally known object detection techniques to identify content items including objects that relate to the event. In some embodiments, the event-based story module 310 may employ generally known text recognition techniques (e.g., optical character recognition) to identify content items including text that relates to the event (e.g., marquee signs providing event details). In some embodiments, users may have the option to insert content overlays that are associated with a given event. These content overlays can include event-specific stickers (e.g., stickers referencing a particular concert, music festival, conference, etc.) and/or entity-specific stickers (e.g., stickers referencing a concert performer, conference speaker, etc.) that can be inserted in content items. In such embodiments, content items that include content overlays referencing the given event can be grouped with content items from which the multi-author story for the event will be generated.

In some embodiments, a multi-author story may be generated using content items that originate from to one or more pre-defined user accounts. In such embodiments, the account-based story module 312 can generate the multi-author story by grouping content items that were posted from the pre-defined user accounts. For example, a news themed multi-author story can be generated using content items posted from pre-defined user accounts that publish news related content for some geographic region (e.g., local news for a given city or region).

In some embodiments, a multi-author story may be generated using content items that were captured at a given time (e.g., moment) or within some pre-defined time period (e.g., morning, afternoon, evening). In such embodiments, the time-based story module 314 can generate the multi-author story by grouping content items that correspond to the given time or time period. Such content items may be identified, for example, based on their respective timestamps. In some embodiments, such content items may be identified based on content overlays inserted in the content items that indicate a time at which a content item was captured. These content overlays may include analog or digital clock stickers.

In some embodiments, a multi-author story may be generated using content items that correspond to a pre-defined media type (e.g., image, video, audio). In such embodiments, the media-based story module 316 can generate the multi-author story by grouping content items that correspond to the pre-defined media type. For example, a multi-author story can be generated from videos only.

In some embodiments, a multi-author story may be generated using content items that correspond to live broadcasts (e.g., live video broadcast or live audio broadcast). In such embodiments, the live content story module 318 can generate the multi-author story by grouping live broadcasts that are being streamed through the social networking system. In some embodiments, the live content story module 318 can generate a multi-author story by grouping live broadcasts from verified user accounts (e.g., accounts corresponding to public figures, celebrities, brands, etc.). In some embodiments, the live content story module 318 can generate a user-specific multi-author story using live broadcasts by entities that are being followed by the user, from live broadcasts that are being viewed (or were being viewed) by persons followed by the user, or a combination thereof. In some embodiments, the live content story module 318 can generate a user-specific multi-author story using live broadcasts that are popular in a given geographic region (e.g., city, state, country, etc.) and/or from live broadcasts that are conducted in a particular language. In some embodiments, the live content story module 318 can generate a multi-author story using popular live broadcasts that are being viewed by a threshold number of users.

In some embodiments, a multi-author story may be generated using content items that include trending subject matter. In such embodiments, the trending story module 320 can identify trending subject matter using any of the approaches described herein. For example, the trending story module 320 can determine that a threshold number of content items that include the same (or similar) subject matter were posted over some period of time. In this example, the trending story module 320 can use content items that include the trending subject matter to generate a corresponding multi-author story. For example, a threshold number of content items posted on a given day may include a “snow day” sticker. In this example, the trending story module 320 can determine that the “snow day” sticker is trending. The trending story module 320 can then group content items in which the “snow day” sticker appears for purposes of generating a corresponding “snow day” multi-author story.

In some embodiments, a multi-author story may be generated using content items that include certain sounds or music (e.g., songs). In such embodiments, the sound-based story module 322 can generate the multi-author story by grouping content items in which pre-defined sounds or songs can be heard. In some embodiments, the sound-based story module 322 can generate a multi-author story corresponding to a given song by grouping content items in which at least a portion of the song is audible. In some embodiments, the order in which these content items are presented is determined based on the playback sequence of the song. In such embodiments, the content items can be ordered so that the portions of the song captured by the content items correspond to the playback sequence of the song. Thus, for example, a first portion of a song may be captured in a first content item, a second portion of the song may be captured in a second content item, and a third portion of the song may be captured in a third content item. In this example, the first content item can be presented before the second content item and the second content item can be presented before the third content item.

In various embodiments, the ranking module 324 can be configured to rank content items that were grouped by any of the modules described above. In some embodiments, content items in a group are ranked based on their respective view counts, number of likes, number of comments, number of re-shares, or any combination thereof.

FIG. 3B illustrates an example content distribution module 352, according to an embodiment of the present disclosure. In some embodiments, the content distribution module 208 of FIG. 2 can be implemented with the content distribution module 352. As shown in the example of FIG. 3B, the content distribution module 352 can include a location-based distribution module 354, an interest-based distribution module 356, and a follower-based distribution module 358.

In various embodiments, the content distribution module 352 can be configured to provide users with access to multi-author stories. As mentioned, in some embodiments, each multi-author story can be associated with certain access criteria that must be satisfied before a user is able to access the multi-author story.

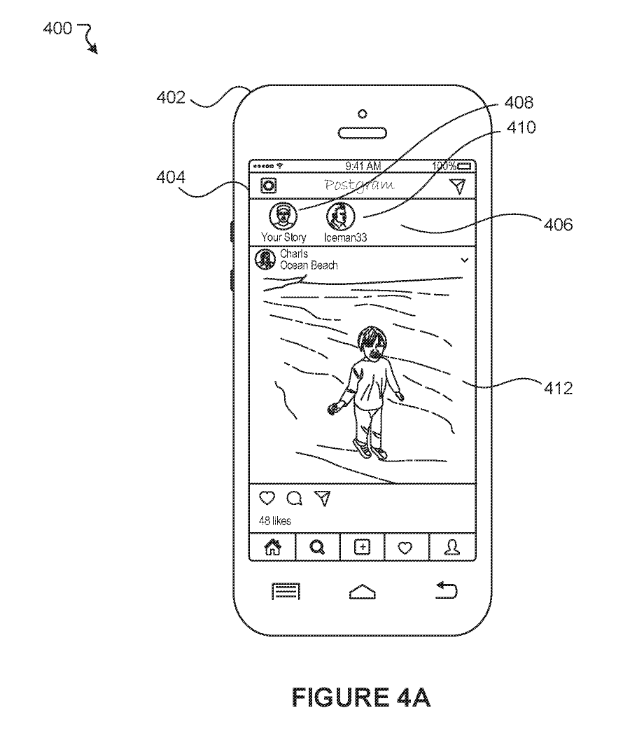

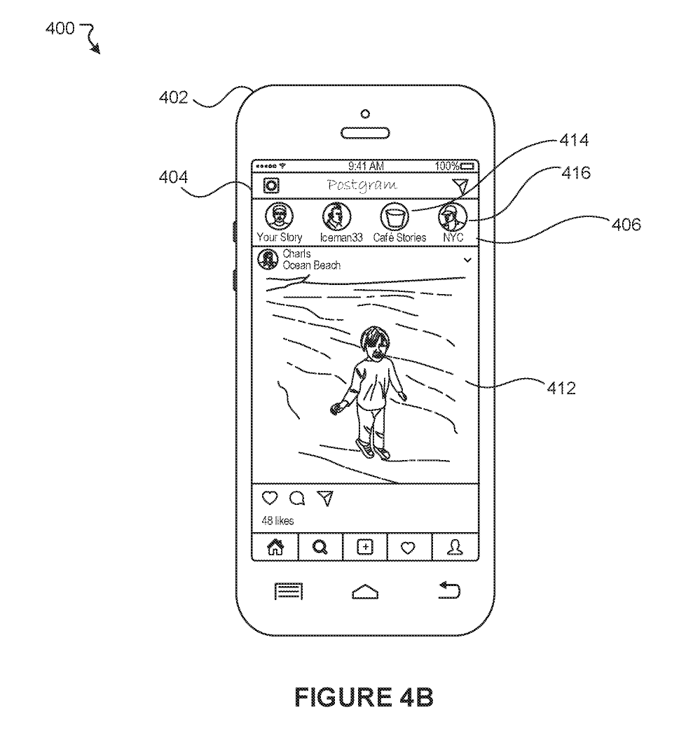

In some embodiments, multi-author stories are associated with location-based access restrictions. For example, access to a multi-author story that corresponds to a given geographic location can be restricted to users that are located in the geographic location. In such embodiments, the location-based distribution module 354 can identify users that satisfy the location-based access restrictions associated with the multi-author story. The location-based distribution module 354 can then provide these users with access to the multi-author story, as illustrated in the example interfaces of FIGS. 4A-B.

In some embodiments, multi-author stories are associated with interest-based access restrictions. For example, access to a given multi-author story can be restricted to users that have demonstrated one or more pre-defined interests (e.g., fashion, sports, music, etc.). In such embodiments, the interest-based distribution module 356 can identify users that satisfy the interest-based access restrictions associated with the multi-author story. The interest-based distribution module 356 can then provide these users with access to the multi-author story, as illustrated in the example interfaces of FIGS. 4A-B.

In some embodiments, multi-author stories are associated with follower-based access restrictions. For example, access to a given multi-author story can be restricted to users that are following one or more pre-defined user accounts through the social networking system. In such embodiments, the follower-based distribution module 358 can identify users that satisfy the follower-based access restrictions associated with the multi-author story. The follower-based distribution module 358 can then provide these users with access to the multi-author story, as illustrated in the example interfaces of FIGS. 4A-B. In some embodiments, a multi-author story may be associated with more than one access restriction. For example, a multi-author story may be associated with a location-based access restriction, an interest-based access restriction, a follower-based access restriction, or any combination thereof.

FIG. 4A illustrates an example 400 of an interface 404, according to an embodiment of the present disclosure. In this example, the interface 404 is presented through a display screen of a computing device 402. Further, the interface 404 may be provided through an application (e.g., a web browser, a social networking application, messenger application, etc.) running on the computing device 402 that is configured to interact with a social networking system.

In the example of FIG. 4A, the interface 404 provides access to ephemeral stories through a first region 406 of the interface 404 and access to a non-ephemeral content feed of a user operating the computing device 402 through a second region 412 of the interface 404. In this example, the first region 406 includes a story 408 corresponding to the user operating the computing device 402 and a story 410 corresponding to another user of the social networking system. As mentioned, the user can post content items to the story 408. Content items posted in the user's story 408 can be accessed by other users of the social networking system. Further, the user can access the story 410 to view content items that were posted by the other user.

In some embodiments, multi-author stories can be generated using any of the approaches described above either alone or in combination. In such embodiments, access to multi-author stories can be provided to eligible users through the first region 406 of the interface 404. For example, as illustrated in the example of FIG. 4B, the user is provided access to a café themed multi-author story 414 and a city themed multi-author story 416. In this example, the café themed multi-author story 414 and the city themed multi-author story 416 were generated by grouping content posted through the social networking system based on various criteria associated with each multi-author story, as discussed above in relation to the content grouping module 302. In some embodiments, the distribution of multi-author stories can be restricted according to some pre-defined criteria (e.g., location-based access restrictions). In this example, the user is shown the café themed multi-author story 414 and the city themed multi-author story 416 after determining the user satisfies the respective pre-defined access criteria associated with the multi-author stories, as described above in relation to the content distribution module 352.

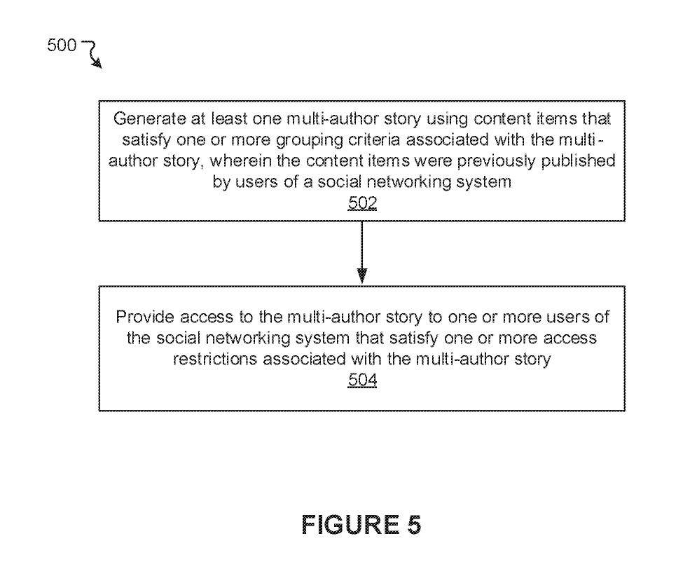

FIG. 5 illustrates an example method 500, according to an embodiment of the present disclosure. It should be appreciated that there can be additional, fewer, or alternative steps performed in similar or alternative orders, or in parallel, within the scope of the various embodiments discussed herein unless otherwise stated.

At block 502, at least one multi-author story is generated using content items that satisfy one or more grouping criteria associated with the multi-author story, wherein the content items were previously published by users of a social networking system. At block 504, access to the multi-author story is provided to one or more users of the social networking system that satisfy one or more access restrictions associated with the multi-author story.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102 of FIG. 1. In some embodiments, the content provider module 646, in whole or in part, is also implemented in the user device 610. As discussed previously, it should be appreciated that there can be many variations or other possibilities.

### Hardware Implementation

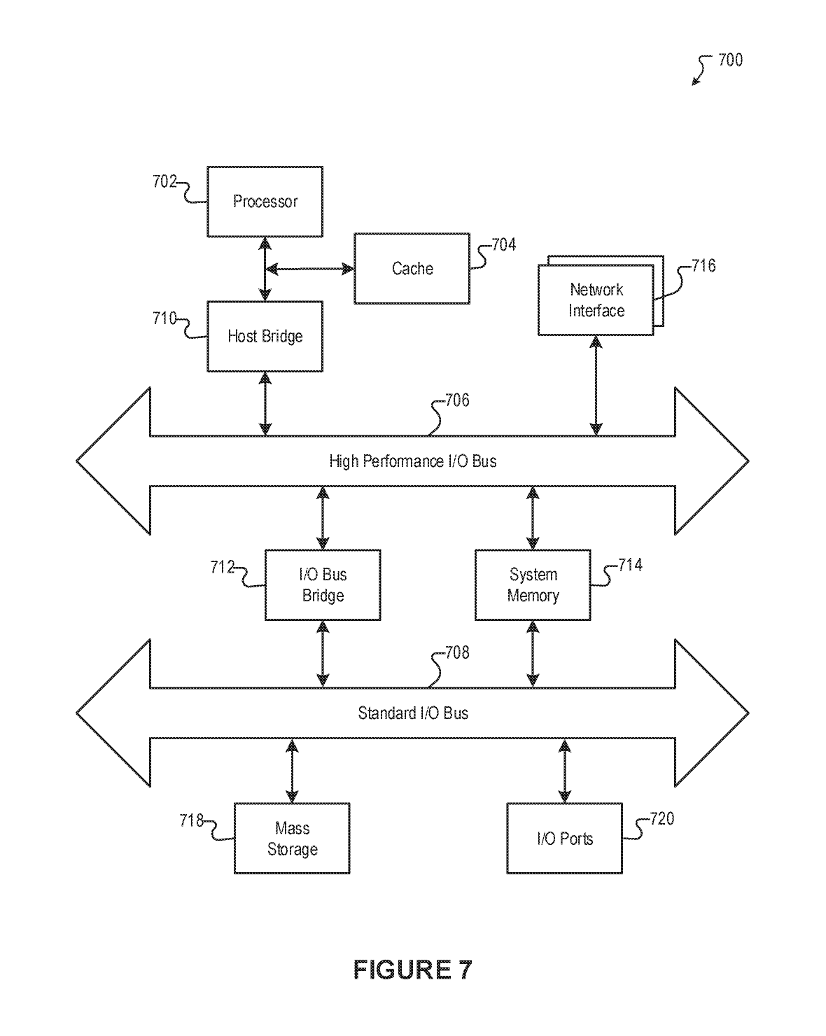

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
generating, by a computing system, at least one multi-author story using content items that satisfy one or more grouping criteria associated with the multi-author story, wherein the content items were previously published by users of a social networking system; and
providing, by the computing system, access to the multi-author story to one or more users of the social networking system that satisfy one or more access restrictions associated with the multi-author story.

2. The computer-implemented method of claim 1, wherein the multi-author story corresponds to a given geographic location, and wherein the multi-author story is generated by grouping content items that correspond to the geographic location.

3. The computer-implemented method of claim 2, wherein a content item corresponding to the geographic location is identified based at least in part on text associated with the content item, geolocation information associated with the content item, subject matter captured in the content item, or content overlays inserted in the content item that reference the geographic location.

4. The computer-implemented method of claim 1, wherein the multi-author story corresponds to a given event, and wherein the multi-author story is generated by grouping content items that correspond to the event.

5. The computer-implemented method of claim 1, wherein the multi-author story corresponds to live broadcasts, and wherein the multi-author story is generated by grouping live broadcasts being streamed through the social networking system.

6. The computer-implemented method of claim 1, wherein the multi-author story corresponds to a given song, and wherein the multi-author story is generated by grouping content items in which at least a portion of the given song is audible.

7. The computer-implemented method of claim 1, wherein the multi-author story corresponds to trending subject matter, and wherein the multi-author story is generated by grouping content items that include the trending subject matter.

8. The computer-implemented method of claim 1, wherein access to the multi-author story is restricted to users that are located in one or more pre-defined geographic locations.

9. The computer-implemented method of claim 1, wherein access to the multi-author story is restricted to users that have demonstrated one or more pre-defined interests.

10. The computer-implemented method of claim 1, wherein access to the multi-author story is restricted to users that are following one or more pre-defined user accounts in the social networking system.

11. A system comprising:
at least one processor; and
a memory storing instructions that, when executed by the at least one processor, cause the system to perform:
generating at least one multi-author story using content items that satisfy one or more grouping criteria associated with the multi-author story, wherein the content items were previously published by users of a social networking system; and
providing access to the multi-author story to one or more users of the social networking system that satisfy one or more access restrictions associated with the multi-author story.

12. The system of claim 11, wherein the multi-author story corresponds to a given geographic location, and wherein the multi-author story is generated by grouping content items that correspond to the geographic location.

13. The system of claim 12, wherein a content item corresponding to the geographic location is identified based at least in part on text associated with the content item, geolocation information associated with the content item, subject matter captured in the content item, or content overlays inserted in the content item that reference the geographic location.

14. The system of claim 11, wherein the multi-author story corresponds to a given event, and wherein the multi-author story is generated by grouping content items that correspond to the event.

15. The system of claim 11, wherein the multi-author story corresponds to live broadcasts, and wherein the multi-author story is generated by grouping live broadcasts being streamed through the social networking system.

16. A non-transitory computer-readable storage medium including instructions that, when executed by at least one processor of a computing system, cause the computing system to perform a method comprising:
generating at least one multi-author story using content items that satisfy one or more grouping criteria associated with the multi-author story, wherein the content items were previously published by users of a social networking system; and
providing access to the multi-author story to one or more users of the social networking system that satisfy one or more access restrictions associated with the multi-author story.

17. The non-transitory computer-readable storage medium of claim 16, wherein the multi-author story corresponds to a given geographic location, and wherein the multi-author story is generated by grouping content items that correspond to the geographic location.

18. The non-transitory computer-readable storage medium of claim 17, wherein a content item corresponding to the geographic location is identified based at least in part on text associated with the content item, geolocation information associated with the content item, subject matter captured in the content item, or content overlays inserted in the content item that reference the geographic location.

19. The non-transitory computer-readable storage medium of claim 16, wherein the multi-author story corresponds to a given event, and wherein the multi-author story is generated by grouping content items that correspond to the event.

20. The non-transitory computer-readable storage medium of claim 16, wherein the multi-author story corresponds to live broadcasts, and wherein the multi-author story is generated by grouping live broadcasts being streamed through the social networking system.
